(19) United States
(12) Patent Application Publication
(10) Pub. No.: US 2018/0259884 A1
(43) Pub. Date: Sep. 13, 2018

(54) IMAGE FORMING APPARATUS

(71) Applicant: CANON KABUSHIKI KAISHA, Tokyo (JP)

(72) Inventor: Takaaki Watanabe, Tokyo (JP)

(21) Appl. No.: 15/910,479

(22) Filed: Mar. 2, 2018

(30) Foreign Application Priority Data
Mar. 7, 2017 (JP) 2017-042541

(51) Int. Cl. G03G 15/16

(52) U.S. Cl. CPC G03G 15/1675; G03G 15/5029

(57) ABSTRACT

Disclosed is an image forming apparatus, including a transfer member configured to transfer a toner image formed on the image bearing member to a recording medium at a transfer portion, wherein an adjustment mode can be performed in which a transfer voltage applied to the transfer portion is controlled to be a first voltage when an upstream predetermined region located upstream of a leading end predetermined region of the recording medium in a conveying direction of the recording medium passes through the transfer portion, and the transfer voltage is controlled to be a second voltage which is less than the first voltage when the leading end predetermined region passes through the transfer portion, and wherein the leading end predetermined region has an area divided into areas in a width direction which is orthogonal to the conveying direction and the first voltage is changed based on image ratios of the areas.

### BACKGROUND OF THE INVENTION

### Field of the Invention

The present invention relates to an image forming apparatus using an electro-photographic process such as a copying machine and a printer.

### Description of the Related Art

Conventionally, in an image forming apparatus that transfers a toner image born on an image bearing member to a sheet as a recording medium by applying a transfer voltage, the sheet is charged by the transfer of the electric charge to the sheet from the image bearing member when passing through the transfer portion due to the influence of an electric field for transferring a toner image. Therefore, in the case of a particularly thin sheet, the leading end portion of the sheet may be adsorbed to the image bearing member by the electrostatic force caused by electrification. The sheet that has passed through the transfer portion must be conveyed while being separated from the image bearing member. However, when the leading end portion of the sheet is adsorbed on the image bearing member as described above, there is a problem that the sheet is wound around the image bearing member to cause separation failure.

In order to deal with this problem, it is proposed that a voltage applying portion is controlled such that the leading end current whose polarity is set to be opposite to the transfer polarity flows through the sheet for example when the leading end portion of the sheet in the conveying direction (non-image region) of the sheet passes through the transfer nip portion which is the pressure contact nip portion between the image bearing member and the transfer member for example (Japanese Patent Application Laid-open No. 2016-90622). As a result, the charge amount of the sheet is controlled and separation failure of the sheet is suppressed.

However, in the transfer voltage control in Japanese Patent Application Laid-open No. 2016-90622, when the leading end portion of the sheet in the conveying direction of the sheet passes through the transfer nip portion, the electrification near the leading end of the sheet for example becomes negative by the influence of the transfer voltage whose polarity is set to a polarity opposite to the transfer polarity at the leading end portion of the sheet in the sheet conveying direction. Then, after the leading end portion of the sheet passes through the transfer nip portion, the polarity of the transfer voltage is changed to the positive polarity. It was found that separation failure may occur at this time by the leading end portion which is charged to the negative polarity receiving an electrostatic force due to the influence of the positive transfer electric field.

From the above, in order to eliminate sheet separation failure immediately after the passing of the sheet through the transfer nip portion, it is desirable to suppress the charge amount of the sheet after the passing of the sheet through the transfer nip portion. As a countermeasure therefor, it is effective to reduce the transfer voltage when the sheet passes through the transfer nip portion. However, when the transfer voltage is reduced, there arises a problem that transfer failure may occur depending on conditions of an image of the sheet (for example, the image ratio) by insufficient electric field necessary for transferring the toner in the transfer nip portion to the sheet.

Therefore, in setting the transfer voltage in the above prior art, it is inevitable to set the transfer voltage at which transfer failure may occur depending on conditions of the image in order not to cause separation failure of the sheet.

### SUMMARY OF THE INVENTION

Therefore, an object of the present invention is to provide an image forming apparatus capable of suppressing separation failure of a recording medium and effectively avoiding an occurrence of image failure.

An image forming apparatus according to the present invention, comprising: an image bearing member; a transfer member to which a transfer voltage is applied, the transfer member being configured to transfer a toner image formed on the image bearing member to a recording medium at a transfer portion; and a control portion configured to control the transfer voltage applied to the transfer member, wherein the control portion is able to perform an adjustment mode in which the transfer voltage is controlled to be a first voltage when an upstream predetermined region which is located upstream of a leading end predetermined region of the recording medium in a conveying direction of the recording medium passes through the transfer portion, and the transfer voltage is controlled to be a second voltage which is less than the first voltage when the leading end predetermined region of the recording medium passes through the transfer portion, and wherein the leading end predetermined region has an area which is divided into a plurality of areas in a width direction which is orthogonal to the conveying direction of the recording medium and the control portion changes the first voltage based on image ratios of the plurality of areas.

According to the present invention, separation failure can be suppressed without greatly impairing the transferability to a sheet by controlling the decrease width of the transfer voltage according to the condition of the image of the leading end portion of the sheet.

Further features of the present invention will become apparent from the following description of exemplary embodiments with reference to the attached drawings.

### BRIEF DESCRIPTION OF THE DRAWINGS

FIG. 1 is an explanatory diagram of the configuration of an image forming apparatus.

FIG. 2 is a table showing the relationship among the transfer voltage, the image ratio in the vicinity of the leading end portion of a sheet, the separability of the sheet and the transferability of toner.

FIG. 3 is a schematic diagram of an image region of the leading end portion of the sheet.

FIG. 4 is a block diagram of the configuration of a transfer voltage control.

FIG. 5 is a flow chart showing control operations for applying a transfer voltage.

FIG. 6 is a graph showing the relationship between the image ratio and the transfer voltage.

FIG. 7 is a timing chart showing the relationship between the printing time and the transfer voltage.

FIG. 8 is a graph showing the relationship among the transfer voltage, the image ratio, the separability of a sheet and the toner transferability.

FIG. 9 is a table showing a verification result of the influence of the position of the transfer nip portion in the sheet width direction on the sheet separability.

FIG. 10 is a graph showing the relationship among the transfer voltage, the image ratio in the central portion of a sheet in sheet width direction, the separability of the sheet and the transferability of toner.

FIG. 11 is a graph showing the relationship among the transfer voltage, the image ratio in the end portion of a sheet in the sheet width direction, separability of the sheet and transferability of toner.

FIG. 12 is a schematic diagram of the leading end image forming region in the sheet width direction.

FIG. 13 is a graph showing the relationship between the end portion of the leading end image region in the sheet width direction and the overall image ratio.

### DESCRIPTION OF THE EMBODIMENTS

Next, an image forming apparatus according to an embodiment of the present invention will be described with reference to the drawings.

### Reference Example

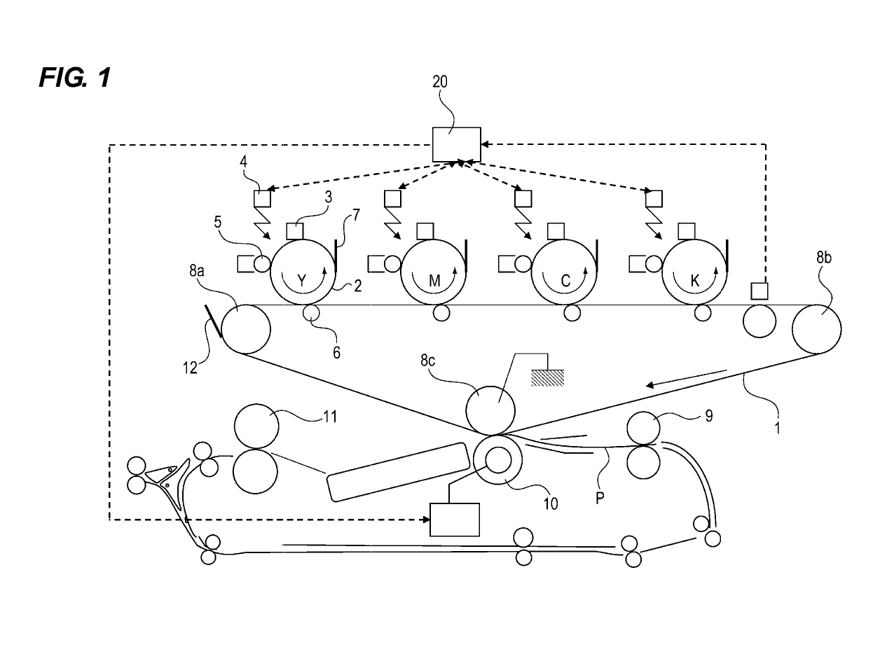

FIG. 1 is a schematic explanatory diagram of an image forming apparatus according to a reference example. The image forming apparatus of this reference example is an intermediate transfer type electro-photographic image forming apparatus and primarily transfers a toner image formed on a photosensitive drum as an image bearing member to an intermediate transfer belt as a second image bearing member, and secondarily transfers the toner image on the intermediate transfer belt to a conveyed sheet at a secondary transfer portion to form an image.

<Overall Configuration of Image Forming Apparatus>

In the image forming apparatus of this reference example, the intermediate transfer belt 1 as an image bearing member is stretched around the driving roller 8a, the tension roller 8b and the secondary transfer inner roller 8c and is rotated counterclockwise as shown in FIG. 1 by rotation of the driving roller 8a.

Four image forming portions for respectively forming toner images of yellow (Y), magenta (M), cyan (C) and black (K) are juxtaposed along the intermediate transfer belt 1 in this order from the upstream side in the rotational direction of the intermediate transfer belt 1. These image forming portions differ from each other only in the color of the toner and the configurations thereof are the same. Next, the configuration of the image forming portions will be explained by taking an example of the yellow image forming portion. The charging roller 3, the exposure portion 4, the developing portion 5, the primary transfer roller 6 and the drum cleaning portion 7 are disposed around the photosensitive drum 2 as an image bearing member. Upon image formation, the surface of the photosensitive drum 2 which rotates in the arrow direction is uniformly charged by applying a charging bias to the charging roller 3, and exposure is performed on the surface of the photosensitive drum 2 according to the image signal from the exposure portion 4 thereby forming an electrostatic latent image on the photosensitive drum 2. The electrostatic latent image formed by the exposure portion 4 is a set of small dot images. It is possible to change the density of the toner image formed on the photosensitive drum 1 by changing the density of the dot images. In the present reference example, the maximum density of each color toner image is about 1.5 to 1.7, and the toner deposition amount at the maximum density is about 0.4 to 0.6 mg/cm².

The electrostatic latent image is visualized by developing the electrostatic latent image with yellow toner by the developing portion 5. The developed toner image is primarily transferred onto the intermediate transfer belt 1 by applying a transfer bias to the primary transfer roller 6. Similarly, in the image forming portions for magenta, cyan and black, toner images of magenta, cyan and black are primarily transferred onto the intermediate transfer belt 1 to form a color image.

In synchronization with the formation of the toner image on the intermediate transfer belt 1, the sheet P as a recording medium is conveyed from a sheet cassette (not shown) by a conveying portion such as the conveying roller 9 and so on to the secondary transfer portion. The toner image on the intermediate transfer belt 1 is transferred to the sheet P by applying to the secondary transfer roller 10 a secondary transfer bias having a polarity opposite to that of the toner when the sheet is conveyed at the nip portion (transfer nip portion) between the intermediate transfer belt 1 and the secondary transfer roller 10. The intermediate transfer belt 1 is supported by the secondary transfer inner roller 8c which is the secondary transfer portion.

Then, the sheet to which the toner image is transferred is conveyed to the fixing portion 11 where the toner image is fixed by being heated and pressed, and is discharged to a discharge portion (not shown).

The belt cleaning portion 12 for removing toner and paper dust remaining on the intermediate transfer belt 1 is provided on the downstream side of the intermediate transfer belt 1 with respect to the transfer nip portion.

<Control of Secondary Transfer Voltage>

In the present reference example, the transfer voltage applied to the secondary transfer roller 10 in the secondary transfer portion is controlled according to the image ratio of the image formed on the photosensitive drum 2.

(Relationship Between Image Ratio and Transferability of Toner or Separability of Sheet)

The sheet to which the toner image has been transferred at the transfer nip portion is separated from the intermediate transfer belt 1 and conveyed to the fixing portion 11. At this time, the state of the toner image in the vicinity of the leading end of the sheet may influence separability. This is because the charging polarity of the sheet, the conveying direction of the sheet at the transfer nip portion and the electric field necessary for transferring the toner to the sheet are changed, which affects the separability of the sheet and the transferability to the toner.

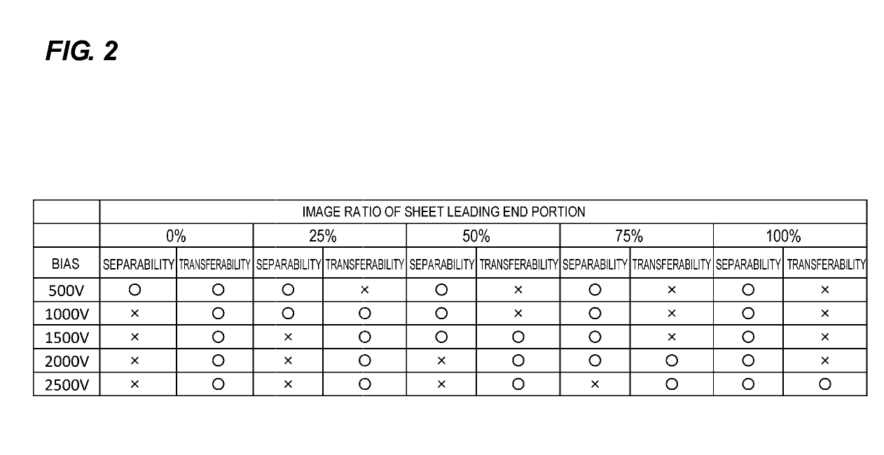

FIG. 2 is a table showing a result of verifying the influence of the image ratio in the vicinity of the leading end of the sheet, the secondary transfer voltage on sheet separability and toner transferability in the image forming apparatus in which the set value of the secondary transfer voltage is 500 V. In FIG. 2, “∘” indicates excellent transfer or an excellent separation, “x” indicates transfer failure or separation failure.

As shown in FIG. 2, as the transfer voltage increases, the toner transferability improves but the separability of the sheet deteriorates. On the other hand, as the transfer voltage decreases, the separability of the sheet improves but the transferability of the toner deteriorates. Further, it is understood that the transfer voltage region in which both the transferability and separability are achieved varies depending on the image ratio (toner deposition amount) in the vicinity of the leading end of the sheet.

The principle that the image ratio affects the separability of the sheet is considered as follows. The state of electric charge movement from the intermediate transfer belt in the part of the sheet to which toner is transferred is different from that in the part to which toner is not transferred due to the air gap between the intermediate transfer belt and the sheet. As a result, the part to which the toner is transferred (high image ratio part) has a weaker electrostatic adsorption force than that in the part to which the toner is not transferred (low image ratio part). Accordingly, it is considered that the separability of the sheet varies according to the image ration.

When the leading end portion of the sheet which has passed through the transfer nip portion is adsorbed to the intermediate transfer belt 1, the sheet is wound around the intermediate transfer belt and is not separated. On the other hand, after the leading end portion of the sheet is separated from the intermediate transfer belt 1, even if the subsequent sheet region is adsorbed to the intermediate transfer belt due to the influence of the transfer voltage, the sheet is separated without being wound around the belt due to the gravity or the like of the separated leading end portion of the sheet.

In view of this, in the present reference example, the secondary transfer voltage is controlled in accordance with the image ratio of the leading end portion of the sheet in order to achieve both the separability and the transferability.

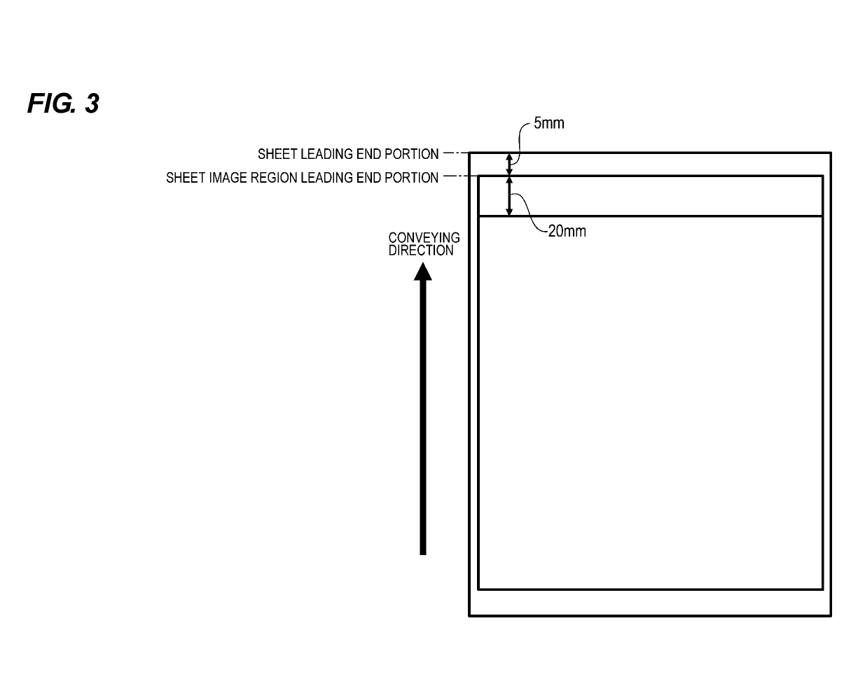

It should be noted that the sheet leading end portion region for calculating the image ratio is a region where when this region is separated from the intermediate transfer belt 1, the subsequent region is also separated from the intermediate transfer belt. Accordingly, although depending on the basis weight of the sheet, the sheet leading end portion region is a region of about 50 mm from the leading end of the sheet. As shown in FIG. 3, in the present reference example, the image ratio of the region of 20 mm from the leading end of the image forming region is calculated. In FIG. 3, since the region of 5 mm from the leading end of the sheet is a blank region and not an image forming region, this region is not included in the image forming region leading end portion.

(Method of Obtaining Image Ratio)

As a method of obtaining the image ratio in the present reference example, the image ratio of each color is obtained based on a video count value. Here, the video count value is a value obtained by integrating the density level (0 to 255) of each pixel in each color image data for the pixels of the image size after conversion of the input image data. For all the pixels of the image size, the ratio to the video count value in the case where all the colors have the highest density levels is taken as the image ratio.

In the present reference example, the video count value is obtained by the conversion into the RGB image data by the control portion 20. In order to obtain the image ratio, the control portion 20 calculates, for example, the image size (for example, A4 size) with respect to the image forming region leading end portion in the sheet conveying direction. Here, the calculated image ratio is described as Gtotal [%].

<Control of Secondary Transfer Voltage>

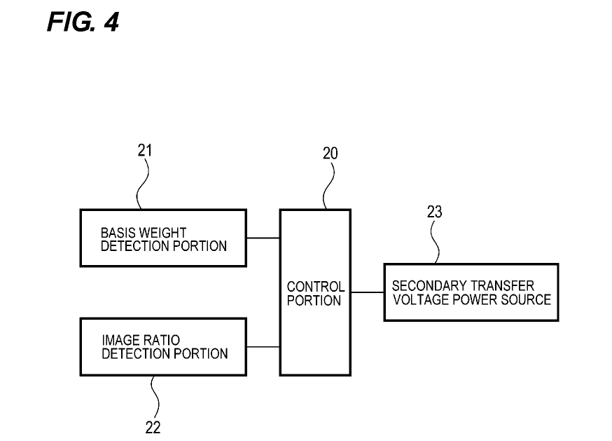

Next, the control of the transfer voltage according to the calculated image ratio will be described. In the present reference example, as shown in FIG. 4, the secondary transfer voltage to be applied to the secondary transfer roller 10 is controlled by the control portion 20. The control portion 20 inputs a detection signal from the basis weight detection portion 21 that detects the basis weight of the sheet and from the image ratio detection portion 22 that detects the image ratio of the sheet image region leading end portion. When the basis weight of the sheet is less than or equal to the preset predetermined value (for example, less than or equal to the basis weight of plain paper), the control portion 20 drives the secondary transfer voltage power source 23 so as to apply a secondary transfer voltage corresponding to the image ratio.

The basis weight detection portion 21 can detect, for example, the type of a sheet inputted by an operator. As described above, the image ratio detection portion 22 detects the image ratio (Gtotal) based on the video count value.

The control portion 20 has a first mode and a second mode (an adjustment mode). In the first mode, a transfer voltage (first voltage) of a standard voltage value is applied to the secondary transfer roller 10 while the sheet is passing through the secondary transfer portion, In the second mode, in the case where a leading end predetermined region of a conveyed sheet is passing through the secondary transfer portion, a transfer voltage to be applied is lowered when the image ratio is low than when the image ratio is high in accordance with the image ratio in the leading end predetermined region, and in the case where the region which is followed by the leading end predetermined region is passing through the secondary transfer portion, a standard voltage is applied. When the basis weight of the sheet is equal to or less than a predetermined value, a transfer voltage (second voltage) by the second mode is applied to the leading end predetermined region.

The transfer voltage value in the first mode is a value set as the standard voltage for secondarily transferring the toner image to the sheet. On the other hand, the transfer voltage value in the second mode is a voltage value lower than the standard voltage value and is varied according to the image ratio.

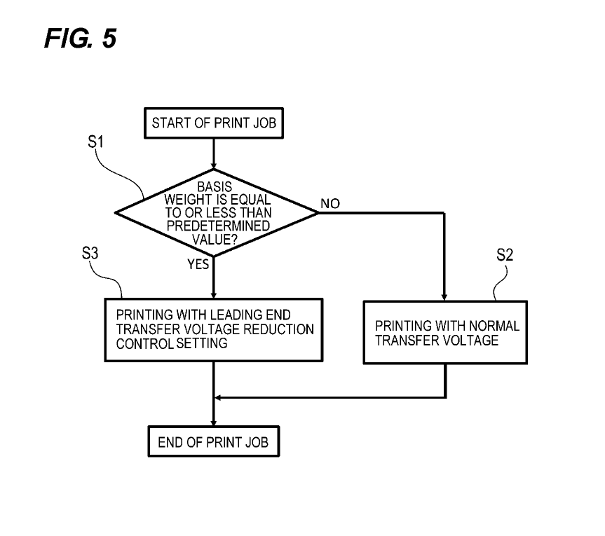

FIG. 5 shows an example of a transfer voltage control flow. When the print job is input, it is judged whether or not the basis weight of the sheet is equal to or less than the predetermined value (step S1). When the basis weight is greater than the predetermined value, it is determined that winding of the sheet on the intermediate transfer belt 1 does not occur even if the standard voltage is applied at the secondary transfer portion, the first mode is selected for the secondary transfer voltage, and the toner image is transferred with the electro-photographic voltage standard value (Vref) which is the secondary transfer voltage (first voltage) of the standard voltage (step S2).

On the other hand, when the basis weight of the sheet is equal to or less than the predetermined value, since the sheet is a thin sheet that is easily wound around the intermediate transfer belt 1 by the application of the secondary transfer voltage, the secondary transfer voltage (second voltage) by the second mode is applied to the sheet image region leading end portion (step S3).

In the secondary transfer voltage control in the second mode, in order to improve the separability of the sheet when the sheet is conveyed to the transfer nip portion, when the image region leading end portion of the sheet enters the transfer nip portion, the transfer voltage reduction control is performed. In the present reference example, a voltage of a transfer voltage application value (Vapply) corresponding to the image ratio is applied to the region of 20 mm in the conveying direction from the leading image region end portion of the sheet. In the image forming apparatus of the present example, the relationship among the image ratio (Gtotal), the transfer voltage reduction value (Voffset), the transfer voltage standard value (Vref), and the transfer voltage calculation value (Vapply) are set as given by the following expressions.

Vapply=Vref−Voffset Expression 1

Voffset=0.5×(1−Gtotal/100)×Vref Expression 2

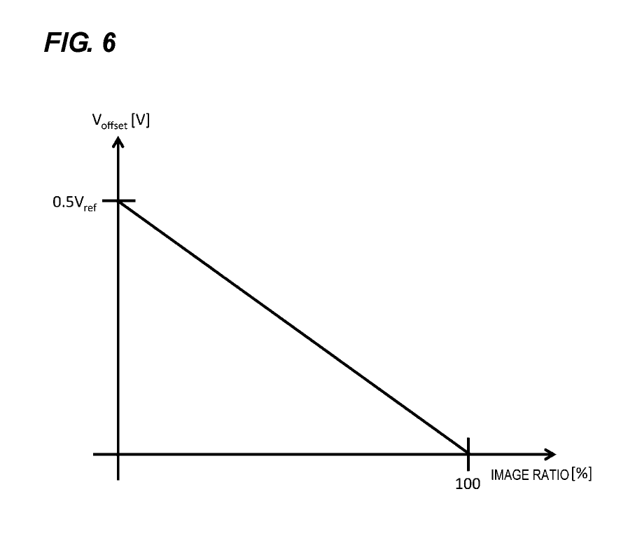

Therefore, in the present reference example, as shown in the graph of FIG. 6, the transfer voltage reduction value (Voffset) is determined according to the image ratio (Gtotal). That is, when the image ratio of the sheet image region leading end portion is 100[%], Vapply=Vref. As the image ratio decreases, the secondary transfer voltage proportionally decreases. The image ratio at the sheet image region leading end portion is 0%, Vapply=0.5×Vref.

As described above, according to the image ratio in the leading end predetermined region of the sheet, the secondary transfer voltage to be applied is controlled to be lower when the image ratio is low than when the image ratio is high. As a result, it is possible to maintain the transferability of the toner satisfactorily while maintaining the separability of the sheet satisfactorily.

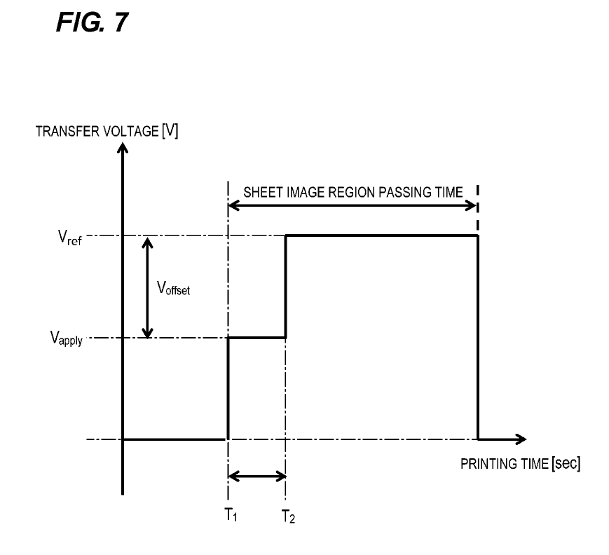

FIG. 7 is a graph showing an example of the relationship between the printing time and the transfer voltage applied to the sheet. From the time (T1) when the image region leading end portion of the sheet passes through the transfer nip portion, to the time (T2) when the position of the image region leading end portion of the sheet (the region of 20 mm in the sheet conveying direction) passes through the transfer nip portion region, the above-described transfer voltage calculation value (Vapply) is applied. After the image region leading end portion of the sheet has passed through the transfer nip portion, the mode is switched to the first mode and the secondary transfer voltage is controlled to be changed to the transfer voltage standard value (Vref).

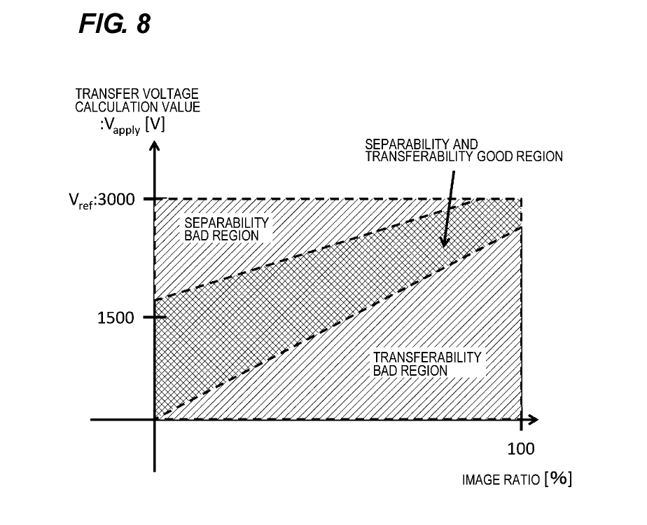

FIG. 8 shows results of checking a good region and bad region for both separability of the sheet and transferability of the toner by changing the image ratio (Gtotal) at the sheet image region leading end portion and the secondary transfer voltage value when forming an image on a sheet whose basis weight is equal to or less than the predetermined value, using an image forming apparatus in which the transfer voltage standard value (Vref) is set as 3000 (V).

As shown in FIG. 8, when the transfer voltage increases at a certain image ratio (Gtotal), the separability of the sheet deteriorates and the transferability of the toner improves. Further, at a certain transfer voltage, when the image ratio (Gtotal) increases, the transferability of the toner deteriorates and the separability of the sheet improves.

Therefore, it can be confirmed that the region in which both the transferability of the toner and the separability of the sheet are good is in the predetermined range (mesh area in FIG. 8) of the transfer voltage and the image ratio (Gtotal).

Therefore, by applying the transfer voltage calculation value according to Equations 1 and 2 to the sheet as the secondary transfer voltage, it is possible to effectively avoid image failure and separation failure in the image forming apparatus in FIG. 8.

It should be noted that 0.5 in Equation 2 is a proportional constant and may be appropriately changed according to the type of the sheet.

In addition, regardless of the above expressions, the control can be performed by previously acquiring good/bad data of sheet separability of the sheet and transferability of the toner for each basis weight of a sheet when changing the image ratio and the transfer voltage shown in FIG. 8, by storing the data table in the control portion, by reading out a transfer voltage in accordance with the basis weight of a conveyed sheet and with the image ratio of the sheet image region leading end portion, and by applying the transfer voltage.

By performing the above-described control, an optimum transfer voltage according to the image ratio of the sheet image region leading end portion is applied, so that separation failure can be suppressed without greatly impairing the transferability of the sheet.

### First Embodiment

An image forming apparatus according to a first embodiment of the present invention will be described. Since the basic configuration of the apparatus of the present embodiment is the same as that of the above-described reference example, duplicate explanation is omitted, and the configuration that is the feature of the present embodiment will be described here. In addition, members having the same functions as those of the above-described reference example are denoted by the same reference characters.

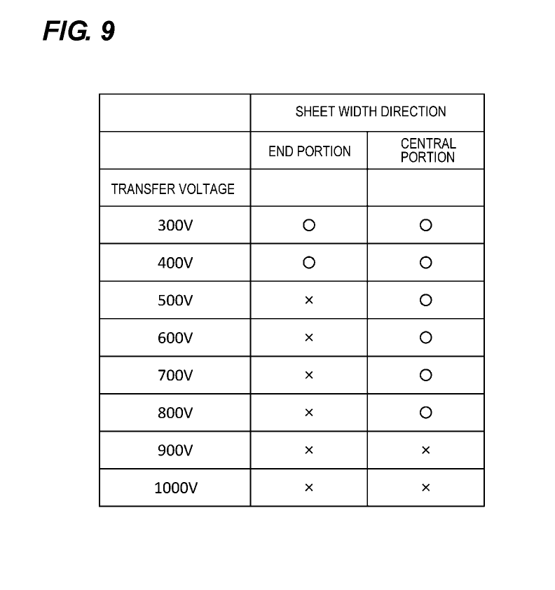

The separability of the sheet at the secondary transfer portion varies depending on the position in the sheet width direction (the direction orthogonal to the sheet conveying direction). FIG. 9 is a table showing results of observing the sheet separability when changing the secondary transfer voltage both at the end portion and at the central portion in the width direction of the sheet in a predetermined image forming apparatus. In FIG. 9, “∘” indicates good separation and “x” indicates separation failure. As can be seen from the table, the threshold voltage for bad separation at the end portion area in the width direction of the sheet is lower than that in the central portion area.

This is because the secondary transfer roller 10 is pressed against the intermediate transfer belt 1 by springs or the like at both end portions in the longitudinal direction (sheet width direction), and a larger load is applied to the end portions than to the central portion. It is considered that sheet separability is different between at the end portions and the central portion because the air gaps between the intermediate transfer belt and the sheet is different due to the load difference so that the charge transfer state from the intermediate transfer belt during the application of the transfer voltage is different.

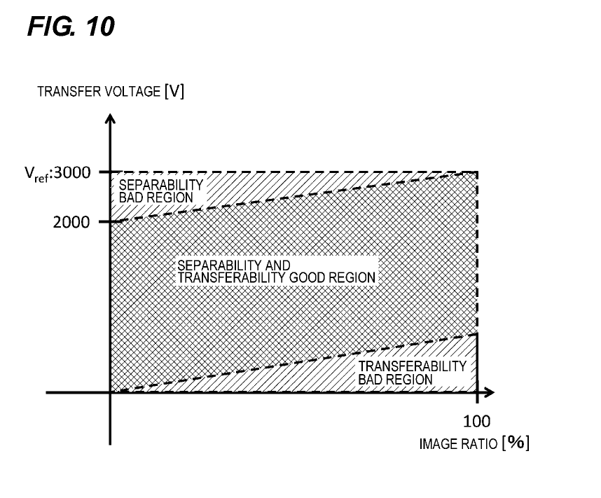

FIG. 10 is a schematic graph showing the investigation result of the relationship among the image ratio at the center portion of the transfer nip portion in longitudinal direction, the transfer voltage, the sheet separability, and transferability of the toner in the case where the image ratio of 100[%] at the end portions of the transfer nip portion in the longitudinal direction (sheet width direction).

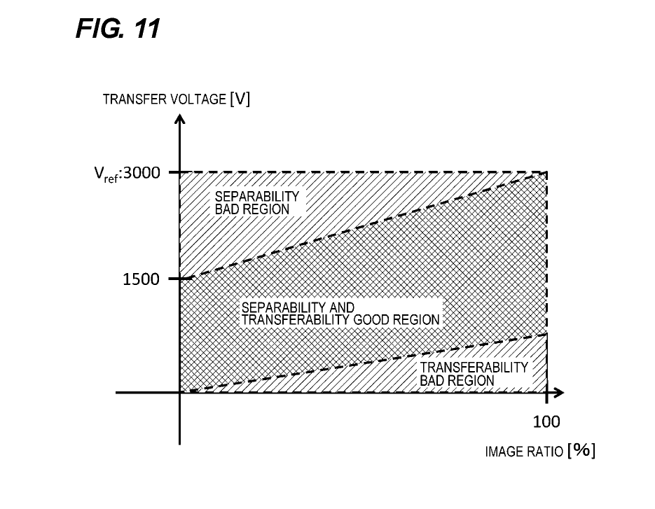

FIG. 11 is a schematic graph showing the investigation results of the relationship among the image ratio at the end portion in the longitudinal direction of the transfer nip portion, transfer voltage, the separability, and transferability in the case where the image ratio at the center portion in the longitudinal direction of the transfer nip portion is 100[%].

It can be confirmed from FIGS. 10 and 11 that the change rate of the sheet separation good/bad threshold voltage with respect to the image ratio is greater at the end portion in the longitudinal direction of the transfer nip portion than at the central portion. That is, in the longitudinal direction of the transfer nip, the sheet separation good/bad threshold voltage changes more greatly when the image ratio at the end portions varies than when the image ratio at the central portion changes.

Therefore, in the case where the image ratio is different between at the end portions and the central portion of the sheet in the longitudinal direction of the transfer nip portion, when setting the transfer voltage, it is desirable to take into consideration the proportions of the image ratio at the both end portions in the longitudinal direction and the image ratio at the central portion in the longitudinal direction respectively about the sheet image region leading end portion.

Therefore, in the present embodiment, in order to suppress bad separation of the sheet without significantly impairing the transferability of the toner, in the case of a thin sheet having a sheet basis weight of a predetermined value or less, an optimum transfer voltage is set according to the image ratio of the central portion and the image ratio of the end portion of in the sheet width direction. Specifically, the secondary transfer voltage is set such that, in the sheet image region leading end portion, the secondary transfer voltage changes more greatly when the image ratio of the sheet end portion areas in the sheet width direction changes than when the image ratio of the central portion area changes.

<Method of Obtaining Image Ratio>

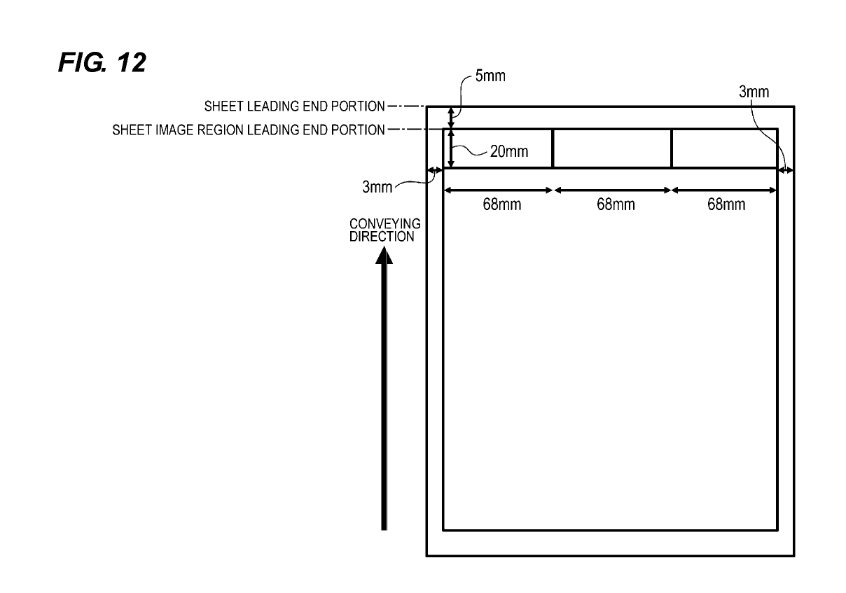

As shown in FIG. 12, in the case of an A4 size sheet for example, the image forming region from which the non-image regions of 3 mm at both ends in the sheet width direction are excluded is equally divided into three areas. Then, the equally divided three areas include a central portion area at the center and end portion areas at both sides in the sheet width direction. The image ratio is calculated for these areas.

In the present embodiment, in order to reflect the influence of the image ratio of the both end portion areas more than that of the central portion area, the image ratio of both end portion areas is doubled to calculate the average value of the overall image ratio. More specifically, when the image ratios of both end portion areas in the longitudinal direction of the sheet are given as Gedge1 and Gedge2 [%] and the image ratio in the central portion area is given as Gcenter [%], the image ratio average value Gtotal [%] of the whole sheet image leading end portion in the width direction is calculated as follows.

Gtotal=(2Gedge1+2Gedge2+Gcenter)/5 Expression 3

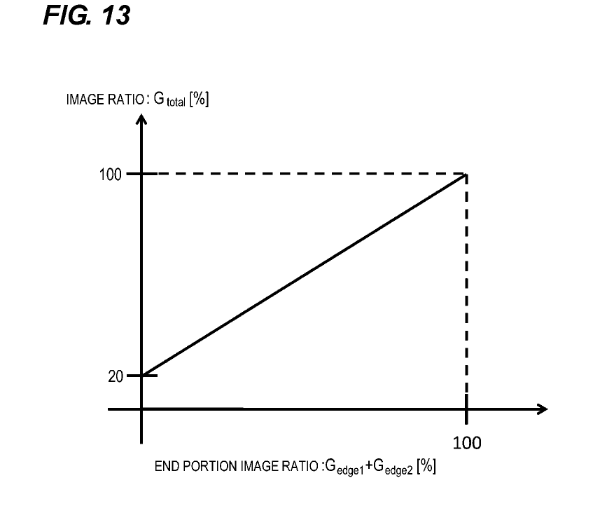

FIG. 13 is a graph showing the relationship between the image ratio (Gedge1+Gedge2) [%] of the end portion areas in the sheet width direction in the case where the image ratio (Gcenter) of the central portion area in the sheet width direction in the Expression 3 is 100% and the image ratio average value (Gtotal) [%] of the whole sheet leading portion in the width direction. It is confirmed from this graph that the image ratio average value (Gtotal) for the whole sheet leading portion in the width direction is 20 [%] when the image ratios (Gedge1, Gedge2) of both end portions in the sheet width direction are zero even if the image ratio of the central portion (Gcenter) in the sheet width direction is 100[%]. That is, even if the image ratio of the central portion occupying ⅓ of whole image region in the width direction is 100[%], the average of the whole image region is 20[%], and the influence of the image ratio of the central portion on the whole image region is less than that of the image ratio of both end portions.

As described above, the image ratio of both end portions in the sheet width direction is doubled to calculate the overall average value, and the transfer voltage is changed according to a change in the image ratio. As a result, the transfer voltage changes more greatly when the image ratio at the both end portions changes than when the image ratio at the central portion in the sheet width direction changes.

When obtaining the image ratio average value (Gtotal), the extent to which the image ratios (Gedge1, Gedge2) at the both end portions are increased in the calculation relative to the image ratio (Gcenter) of the central portion may be changed depending on the type of the sheet or the like.

<Control of Secondary Transfer Voltage>

In the present embodiment, the relationship among the average image ratio (Gtotal), the transfer voltage reduction value (Voffset), the transfer voltage standard value (Vref), and the transfer voltage calculation value (Vapply) is set by the following equation.

Vapply=Vref−Voffset

Voffset=0.67×(1−Gtotal/100)×Vref Expression 4

According to the above Expression 4, when the transfer voltage standard value (Vref) is 3000 [V] and the image ratio average value (Gtotal) of the whole image region in the width direction at the image region leading end portion of the sheet is 20[%] for example, the transfer voltage calculation value (Vapply) is 1392 [V]. This is understood from the fact shown in FIG. 11 that the sheet separation good/bad threshold voltage is 1500 [V] when the image ratios (Gedge1, Gedge2) of both end portions in the sheet width direction (that is, when the image ratio average value (Gtotal) is 20[%]) are zero in the case where the image ratio of central portion (Gcenter) in the sheet width direction is 100[%].

Therefore, by changing the transfer voltage more greatly when the image ratio of the end portion areas in the sheet width direction changes based on the above-mentioned Expressions 3 and 4 than when the image ratio of the central portion area changes, it is possible to more reliably achieve an improvement of both separability of the sheet and transferability of the toner.

It should be noted that 0.67 in Equation 4 is a proportional constant and may be appropriately changed according to the type of a sheet.

In addition, also in the present embodiment, similarly to the above-described reference example, regardless of the above Expressions, the control can be performed by acquiring data of sheet separability of the sheet and transferability of the toner for each basis weight of the sheet when changing the image ratio and the transfer voltage shown in FIG. 11, by storing the data table in the control portion, by reading out a transfer voltage in accordance with the basis weight of a conveyed sheet and with the image ratio of the sheet image region leading end portion, and by applying the transfer voltage.

The present embodiment has been explained by the example in which the threshold voltage of separation failure in the end portion areas in the width direction of a sheet is lower than in the central portion area, but the present invention is not limited thereto. The present invention can be applied to the case where the threshold voltage of separation failure in the end portion areas in the width direction of a sheet is higher than in the central portion area.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-042541, filed Mar. 7, 2017, which is hereby incorporated by reference herein in its entirety.

What is claimed is:

1. An image forming apparatus, comprising:
an image bearing member;
a transfer member to which a transfer voltage is applied, the transfer member being configured to transfer a toner image formed on the image bearing member to a recording medium at a transfer portion; and
a control portion configured to control the transfer voltage applied to the transfer member,
wherein the control portion is able to perform an adjustment mode in which the transfer voltage is controlled to be a first voltage when an upstream predetermined region which is located upstream of a leading end predetermined region of the recording medium in a conveying direction of the recording medium passes through the transfer portion, and the transfer voltage is controlled to be a second voltage which is less than the first voltage when the leading end predetermined region of the recording medium passes through the transfer portion, and
wherein the leading end predetermined region has an area which is divided into a plurality of areas in a width direction which is orthogonal to the conveying direction of the recording medium and the control portion changes the first voltage based on image ratios of the plurality of areas.

2. The image forming apparatus according to claim 1,
wherein an image forming region of the leading end predetermined region is equally divided into three areas in the width direction which is orthogonal to the conveying direction of the recording medium, the three areas include a first area and a second area which are provided respectively on both end portions in the width direction, and a third area which is provided on a central portion in the width direction,
wherein in the adjustment mode, the second voltage is set to a first predetermined voltage when an image with a first image ratio is formed on the first area and the second area respectively and an image with a second image ratio which is less than the first image ratio is formed on the third area, and
wherein in the adjustment mode, the second voltage is set to a second predetermined voltage which is different from the first predetermined voltage when an image with the first image ratio is formed on the first area and the third area respectively and an image with the second image ratio is formed on the second area.

3. The image forming apparatus according to claim 2,
wherein the second predetermined voltage is greater than the first predetermined voltage.

4. The image forming apparatus according to claim 1,
wherein in a case where an image ratio of an image formed on the first area or the second area changes, a change amount of the transfer voltage at a time when the leading end predetermined region passes through the transfer portion is a first change amount, and
wherein in a case where an image ratio of an image formed on the third area changes, a change amount of the transfer voltage at a time when the leading end predetermined region passes through the transfer portion is a second change amount which is different from the first change amount.

5. The image forming apparatus according to claim 1,
wherein the control portion is able to perform a mode in which a transfer voltage at a time when the leading end predetermined region of the recording medium passes through the transfer portion and a transfer voltage at a time when the upstream predetermined region of the recording medium passes through the transfer portion are set to a same value, and the control portion performs the adjustment mode when a basis weight of the recording medium is less than or equal to a predetermined amount.

6. The image forming apparatus according to claim 1,
wherein a transfer voltage control is performed by the adjustment mode based on a data table according to a basis weight of the recording medium.
